(19) United States
(12) Patent Application Publication
(10) Pub. No.: US 2024/0421983 A1
(43) Pub. Date: Dec. 19, 2024

(54) EVOLVING THRESHOLD FUNCTION SECRET SHARING

(71) Applicant: Seagate Technology LLC, Fremont, CA (US)

(72) Inventors: Foo Yee YEO, Singapore (SG); Hwei Ming Jason YING, Singapore (SG); Nolan Ashvin MIRANDA, Winston-Salem, NC (US)

(21) Appl. No.: 18/742,990

(22) Filed: Jun. 13, 2024

Related U.S. Application Data
(60) Provisional application No. 63/508,561, filed on Jun. 16, 2023.

(51) Int. Cl. H04L 9/08

(52) U.S. Cl. CPC H04L 9/085

(57) ABSTRACT

Evolving function secret sharing is performed on a given function by multiple share parties, A dealer selects a random vector for each share party corresponding to an arrival order. The dealer generates an array of function shares for each share party of the set, each array including a function share based on the random vector corresponding to the share party and one or more function shares cryptographically generated based on the random vector corresponding to each previously-arrived share party. The dealer distributes an array of the function shares to each share party, wherein a first function share result resulting from a computation of a first function share on given input data and at least a second function share result resulting from a computation of a second function share on the given input data are combinable to yield a result of the given function executed on the given input data.

### RELATED APPLICATIONS

The present application claims benefit of priority to U.S. Provisional Patent Application No. 63/508,561, entitled “Evolving Threshold Function Secret Sharing” and filed on Jun. 16, 2023, which is specifically incorporated by reference for all that it discloses and teaches.

### SUMMARY

In some aspects, the techniques described herein relate to a computing-processor-implemented method of performing evolving function secret sharing on a given function by multiple share parties, the computing-processor-implemented method including: selecting, by a dealing party, a random vector for each share party of a set of multiple share parties, the random vector of each share party corresponding to an arrival order at which each share party arrived to be added to a set of the multiple share parties; generating, by the dealing party, an array of function shares for each share party of the set of the multiple share parties, each array including a function share based on the random vector corresponding to the share party and one or more function shares cryptographically generated based on the random vector corresponding to each previously-arrived share party, and distributing an array of the function shares to each share party, wherein a first function share result resulting from a computation of a first function share on given input data and at least a second function share result resulting from a computation of a second function share on the given input data are combinable to yield a result of the given function executed on the given input data, the first function share being selected from an array of a previously-arrived share party and the second function share being selected from an array of a later-arriving share party. More generally, function shares, function share results, and function share arrays may be referred to as shares, share results, and share arrays, respectively.

In some aspects, the techniques described herein relate to a computing device for performing evolving function secret sharing on a given function by multiple share parties, the computing device including: one or more hardware processors; a random vector sampler executable by the one or more hardware processors and configured to select, by a dealing party, a random vector for each share party of a set of multiple share parties, the random vector of each share party corresponding to an arrival order at which each share party arrived to be added to a set of the multiple share parties; a function share generator executable by the one or more hardware processors and configured to generate, by the dealing party, an array of function shares for each share party of the set of the multiple share parties, each array including a function share based on the random vector corresponding to the share party and one or more function shares cryptographically generated based on the random vector corresponding to each previously-arrived share party, and a share distributor executable by the one or more hardware processors and configured to distribute an array of the function shares to each share party, wherein a first function share result resulting from a computation of a first function share on given input data and at least a second function share result resulting from a computation of a second function share on the given input data are combinable to yield a result of the given function executed on the given input data, the first function share being selected from an array of a previously-arrived share party and the second function share being selected from an array of a later-arriving share party.

In some aspects, the techniques described herein relate to one or more tangible processor-readable storage media embodied with instructions for executing on one or more processors and circuits of a computing device a process for performing evolving function secret sharing on a given function by multiple share parties, the process including: selecting, by a dealing party, a random vector for each share party of a set of multiple share parties, the random vector of each share party corresponding to an arrival order at which each share party arrived to be added to a set of the multiple share parties; generating, by the dealing party, an array of function shares for each share party of the set of the multiple share parties, each array including a function share based on the random vector corresponding to the share party and one or more function shares cryptographically generated based on the random vector corresponding to each previously-arrived share party, and distributing an array of the function shares to each share party, wherein a first function share result resulting from a computation of a first function share on given input data and at least a second function share result resulting from a computation of a second function share on the given input data are combinable to yield a result of the given function executed on the given input data, the first function share being selected from an array of a previously-arrived share party and the second function share being selected from an array of a later-arriving share party.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates example electronic systems useful in evolving function secret sharing.

FIG. 2 illustrates an example system for generating a new function share for a newly arriving share party by a dealing party.

FIG. 3 illustrates an example of two share parties combining to construct a result R in an implementation with a threshold of two.

FIG. 4 illustrates an example generational structure employable in an implementation of the described technology.

FIG. 5 illustrates an example system for performing evolving function secret sharing on a given function by multiple share parties.

FIG. 6 illustrates example operations for performing evolving function secret sharing on a given function by multiple share parties.

FIG. 7 illustrates an example computing device for use in implementing the described technology.

### DETAILED DESCRIPTIONS

In some computing scenarios, a data owner may wish to outsource storage to multiple third-party servers. If the data owner wishes to compute a function f on the stored data without revealing the function, then techniques such as homomorphic encryption and multiparty computation (MPC) are not appropriate solutions because these methods require the function to be known to at least one computing entity. In contrast, function secret sharing (FSS), with appropriate constraints and computational operations, can allow a set of parties (e.g., computing servers) to evaluate a function in an oblivious manner, maintaining the secrecy of the function f with respect to these parties.

A capability of employing multiple parties to evaluate a function f without any of the parties knowing f itself has many direct applications, including without limitation:
Searching over encrypted data without requiring decryption,
Retrieving data from servers without revealing what was retrieved, and
Privately extracting sensitive information from a pool of seemingly innocuous data.

As such, companies often have computational functions that the companies would prefer to keep private from third parties. For example, Netflix's recommendation algorithm is a valuable proprietary computational function, so Netflix would prefer to hide the recommendation algorithm from outside server resources that may be performing the associated computations. Such privacy concerns can sometimes be addressed with a cryptographic scheme, referred to as function secret sharing, in which the individual servers receive function shares to compute a portion of the output without being able to learn anything about the original function. However, as the user base grows, Netflix may need to employ more servers to bear the load of additional computation requests to calculate this function. In some function sharing schemes, function shares are computed with respect to a fixed maximum number of servers and are inflexible to additional servers being added in the future because all function shares would need to be refreshed even to add one additional server. However, an evolving function secret sharing scheme would allow Netflix to distribute new function shares as servers get added without having to refresh the function shares of the existing servers. An evolving function secret sharing scheme would let the function secret sharing scheme be robust to the expansion of the number of servers.

Function secret sharing allows a dealing party to secretly share a function ƒ from a specified class of functions, such that, given an input x in the domain of the function ƒ, authorized subsets of parties can jointly evaluate ƒ(x) without revealing any other information about ƒ. Typically, the number of parties is fixed at the start of the scheme, and the dealing party deals the function shares to the parties all at once. However, in certain situations, the number of parties might not be known in advance, and parties might be able to join the scheme at any point in time. For example, this type of situation might occur in decentralized contexts, such as blockchains. Furthermore, not having a fixed number of parties at the start of the scheme would allow unavailable parties to be easily replaced.

The described technology introduces the idea of evolving access structures to function secret sharing and a scheme that shares a class of functions for an evolving 2-threshold access structure. A technical benefit of this technology is that it is more flexible as the number of parties participating in the sharing scheme can change without having to refresh the function shares of the existing servers, which reduces computational and communication resource requirements as the number of these parties changes.

As an example, assume a company uses one hundred servers to perform its computation and then decides to add one more server to increase the computation capacity of its system. Without evolving function secret sharing, the company would need to refresh the function shares of the one hundred existing servers and create a new function share for the new server. Then, if the company decides to add yet another server, the company will need to refresh the function shares of the one hundred and one existing servers and create a new function share for the second new server. These refreshes consume significant computational and communication resources, whereas an evolving function secret sharing technology would not require the refreshing of shares for the pre-existing servers, thereby using fewer resources. With evolving function secret sharing, specially-design-computation up front can provide parties with shares that are compatible with incrementally added function shares for new parties in the future.

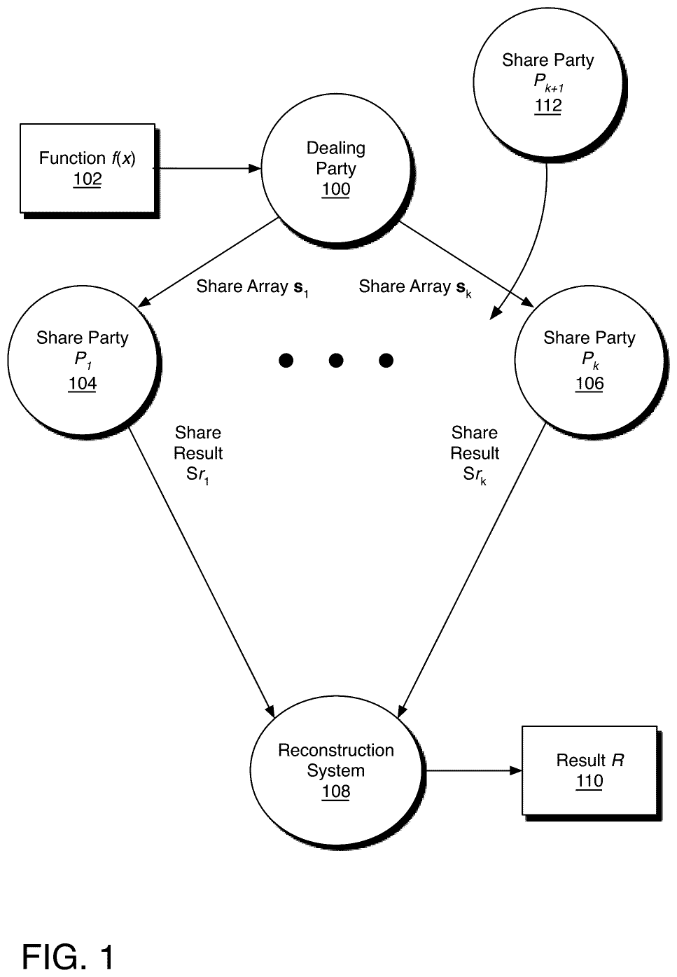

FIG. 1 illustrates example electronic systems useful in evolving function secret sharing. A dealing party (also referred to as a dealer or a share allocating system) possesses a secret function f(x), which is not known by share parties receiving shares of the secret function f(x). In various implementations, a dealing party includes a computing system (e.g., a server or a system of distributed computing devices). Function secret sharing is directed to sharing the secret function f(x) among two or more share parties (also referred to as share result computation systems), such that the share parties can jointly evaluate their respective shares of the secret function f(x) without the complete secret function f(x) being shared with any computing system (e.g., without the complete secret function f(x) being shared with or known by a share party or a reconstruction system). In various implementations, a dealing party and the share parties each include one or more computing systems (e.g., a server or a system of distributed computing devices).

Each function share of f(x) is identified as sᵢ for i=1, . . . , k, where sᵢ denotes an array of shares s_{i,j}, i denotes an order index (the order of arrival of each share party into the set of share parties), j denotes an order index of every previously-arrived share party, and k denotes the number of share parties in the set of share parties usable in this function secret sharing operation. Note that the concept of “arrival” is intended to represent the time at which the share party is being added to the set, and the newly arriving share party is sometimes referred to as a target share party to distinguish it from earlier-arriving share parties. For example, if two share parties arrive to join the set of multiple share parties in sequence (Share Party A arriving first, followed by Share Party B), then Share Party A is the previously-arrived or earlier-arriving party, and Share Party B is the later-arriving or the later-arrived party. A newly arriving shared party identifies the most recent share party to arrive for addition to the set.

The dealing party 100 samples a random vector for each share party and stores that random vector in association with that share party. With this information, the dealing party 100 generates the array of function shares for each share party, wherein each element of the array of function shares corresponds (in order of arrival) to the share parties arriving before that share party arrived and is based at least in part on the random vector associated with each of those earlier-arriving share parties. Details of such generation are described below.

The dealing party 100 passes the corresponding function share array to the target share party. The array includes function shares for each share party that arrived before the target share party. Note that the first arriving share party P₁ would receive an array of function shares with only one element (only one function share) because no other share parties arrived before the first arriving share party P₁.

When two share parties are selected from a set of 1 through k parties to compute a result R 110, each share party computes a function result share Rsᵢ of a function share sᵢ selected from its array based on specified input data y. (Selection by a share party of a function share from the array that is to be used to compute the corresponding share result will be described below.) The complete result of the secret function f(x) (the result being identified as a result R 110) can then be reconstructed from the combined (e.g., summed) result shares Rs from each participating share party.

For example, in one implementation, a dealing party 100 allocates selectively computed function shares s of the secret function f(x) (e.g., a polynomial function 102) to two or more share parties (see, e.g., a share party 104 and a share party 106). Because the share parties do not receive the entire secret function f(x), they cannot discern the entire function by themselves. It should be understood that although the example of FIG. 1 has been described with respect to a combination of share results from two share parties (e.g., a threshold of two), the described technology can be generalized to a threshold greater than two.

The combined result shares Rs computed by the share parties can then be received by a reconstruction system 108 (which can be in the form of the dealing party, a trusted share party, or another electronic system), and the complete result of the function secret sharing operation can be reconstructed from the combined function share results Rs of the share parties. That is, the combined result shares of each share party can be further combined (e.g., summed) according to a reconstruction protocol to yield the full result R (result R 110) of the secret function f(x) without any other computing system (e.g., other than the dealing party) having access to the complete secret function f(x).

In the described technology, a new share party 112 arrives to be added to the set of share parties (1 through k). For example, the k share parties are approaching the limits of their computational capacity, so the owner/operator of these systems decides to add another share party to better balance the load and increase overall computational capacity. However, to avoid refreshing all of the function shares for the previous k share parties, the function shares dealt to the k share parties were initially computed to support evolving threshold function secret sharing, as described herein. Accordingly, the dealing party 100 generates a new function share sₖ₊₁ for the new share party 112 in order to support k+1 share parties. Thereafter, the new share party 112 can participate in the computation of the result R 110.

The described example in FIG. 1 is directed to a threshold equaling two (e.g., the share results of two share parties of a set of k share parties coming together to yield the combined share result. However, the described technology can be generalized to a threshold greater than two. The following descriptions provide more formal statements of example implementation of the function secret sharing articulated herein.

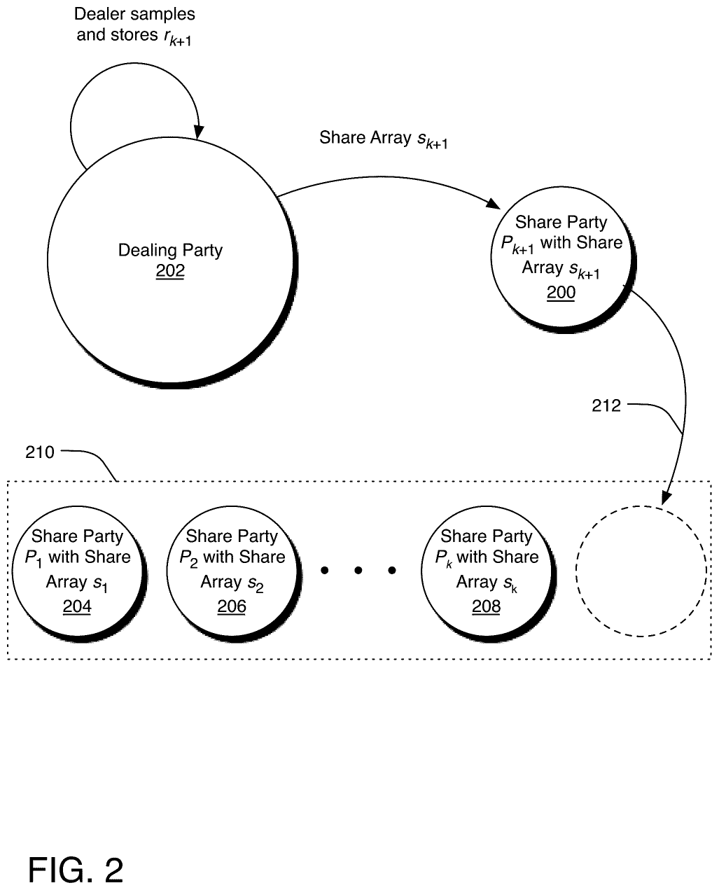

FIG. 2 illustrates an example system for generating a new function share sₖ₊₁ for a newly arriving share party Pₖ₊₁ (new share party 200) at time t+1 by a dealing party 202. The dealing party 202 had previously generated shares for other share parties that arrived at different times. For example, a share party 204 arrives at time 1, with the share party 204 being designated as P₁ and its function share being designated as s₁, a share party 206 arrives at time 2, with the share party 206 being designated as P₂ and its function share being designated as s₂, and a share party 208 arrives at time t, with the share party 208 being designated as Pₖ and its function share being designated as sₖ.

The example generation illustrated in FIG. 2 relies on the time aspect. Each share party that arrives to be added to the set 210 of share parties is associated with a timestamp. The order in which the share parties arrive to be added to the set 210 is represented by their relative timestamps. In other words, the first share party to arrive is denoted as P₁ and is said to arrive at time 1, the second share party to arrive is denoted as P₂ and is said to arrive at time 2, and, generally, each share party Pₜ arrives at time t. Accordingly, t share parties have already arrived into the set 210 when the new share party Pₜ₊₁ arrives. Every time a new share party arrives, the dealing party 202 samples a new random value, which it associates with that new share party, and stores the new random value for future use. As such, the dealing party 202 “remembers” or stores the random vectors r₁, r₂, . . . , rₜ corresponding to the share parties s₁, s₂, . . . , sₜ, and when party Pₜ₊₁ arrives, the dealing party 202 samples and “remembers” or stores a new random vector rₜ₊₁. Each random vector has a length of d+1, where d is the degree of the secret polynomial f(x). The arrow 212 and dashed circle represent the new share party 200 being added to the set 210.

Thereafter, the dealing party 202 uses the t+1 random vectors r₁, . . . , rₜ₊₁ to create an array sₜ₊₁ of length t+1, which is given to Pₜ₊₁. The first t elements of sₜ₊₁ are to correspond with the t parties, which have previously arrived, while the last element sₜ₊₁ corresponds to the newly arriving share party Pₜ₊₁ (new share party 200).

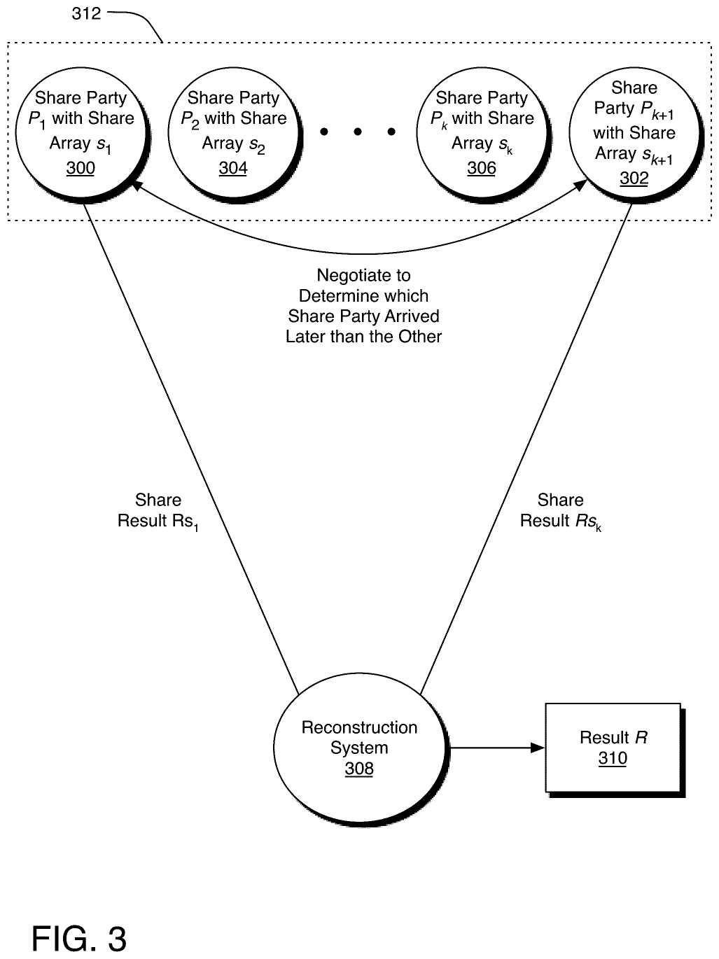

FIG. 3 illustrates an example of a share party 300 and a share party 302 combining to construct a result R in an implementation with a threshold of two. The share party 300 and the share party 302 are two members of a set 312 of share parties having function shares of a secret function f(x). A share party 304 and a share party 306 represent share parties not involved in the current computation, although they may participate in other computation instances because they have received evolving function shares from the dealer. When the share party 300 and the share party 302 decide to reconstruct the result R 310 of the secret function f(x), these two share parties determine which share party arrived later than the other. In this example, the share party 302 (the (k+1)^{th} share party to arrive) arrived after the share party 300 (the first share party to arrive). That is, in this example, k+1>1, so the (later-arrived) share party 302 arrived after the (previously-arrived) share party 300.

In this example, the share party 300 computes a share result Rsᵢ from a specified input data y and the last element in its function share array, designated by s_{1,1}. (Because the order index of the share party 300 is i=1, then its array is of length 1, and so the last element in its array is also the first element in its array.) The share party 302 computes the share result Rsₖ₊₁ from the specified input data y and the first element in its function share array, s_{k+1,1}, because the share party 300 has an order index of one. The first index in the share array notation denotes the order index of the share party, and the second index in the share array notation denotes the order index of the element selected from the share party's array.

More generally, whenever two parties Pₐ and P_{b} want to construct the answer, they negotiate to decide which share party arrived later than the other. Note that the share party Pₐ arrived at time a and the share party P_{b} arrived at time b. Because b>a (party Pₐ arrived first), share party Pₐ uses the last element in its function share array to construct a share result Rsₐ, given an input value y. In contrast, P_{b} selects the ath element in its function share array (since b>a) and uses this ath element to construct a result share Rs_{b}, given the input value y. Based on the way sₐ and s_{b} were generated by the dealing party, these two result shares are sufficient to reconstruct the result R of the secret function ƒ(x), given the input value y.

Turning to the details of an evolving 2-threshold function secret sharing implementation, et [symbol] be a finite field, and let p(X)=a_{d}X^{d}+a_{d-1}X^{d-1}+ . . . =a₁X+a₀∈ [symbol] [X]. Let a=(a₀, . . . , a_{d})∈ [symbol] ^{d+1}. An implementation shares the class of functions

$$\\ {ℙ}_{d} ( 𝔽 ) = \{ p ( X ) ∈ 𝔽 [ X ] : deg ( p ) \leq d \}$$

of polynomials in [symbol] [X] of degree up to d, in which the t-th party has a share size of:

$$\\ t ( d + 1 ) log \vert 𝔽 \vert .$$

### Dealing of Shares:

Assume, for ease of exposition, that the t-th share party Pₜ arrives at time t. At time t, the internal state of the dealing party consists of t elements of [symbol] ^{d+1}: r₁, . . . , rₜ. When Pₜ₊₁ arrives at time t+1, the dealing party:
1. samples rₜ₊₁← [symbol] ^{d+1} uniformly at random,
2. computes

$$\\ {s}_{t + 1 , i} = \{ \begin{matrix}a - {r}_{i} & for i = 1 , … , t , \\ {r}_{t + 1} & for i = t + 1 ,\end{matrix}$$

3. gives Pₜ₊₁ the share sₜ₊₁=(s_{t+1,1}, . . . , s_{t+1,t+1}).

### Evaluation

To evaluate the function ƒ at x, the share parties Pᵢ and Pⱼ(where i<j) does the following:
1. Pᵢ computes Rs_{i,j}(x)=s_{i,i}·(1, x, . . . , x^{d}),
2. Pⱼ computes Rs_{j,i}(x)=s_{j,i}·(1, x, . . . , x^{d}), and
3. a reconstruction system 308 outputs Rs_{i,j}(x)+Rs_{j,i}(x).

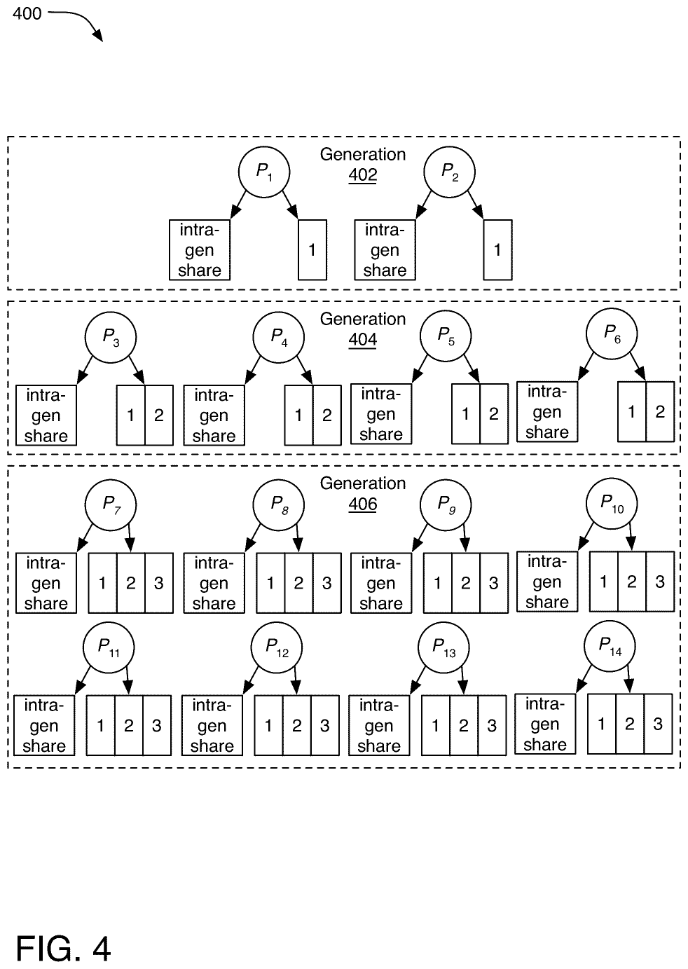

FIG. 4 illustrates an example generational structure 400 employable in an implementation of the described technology. Such an implementation uses the concept of generations to group incoming share parties. Essentially, each generation j has 2^{j} share parties, so the first generation has 2 share parties, the second generation has 4 share parties, the third generation has 8 share parties, and so on. Share parties still arrive one at a time, but the dealing party keeps track of which generation a dealing party is in when the share party arrives. The share party then gets multiple function shares upon arrival: one function share for reconstruction of a result R with one or more other share parties within its generation (called an intra-gen share or intra-generation function share in FIG. 4) and an array of one or more function shares (called a multi-gen share or a multigeneration function share in FIG. 4) for reconstruction of a result R with one or more other share parties with each previous generation (as well as one for successive generations). Successive generations include share parties arriving to the set of multiple share parties after previously-arrived share parties, wherein groups of share parties are combined into distinct generations. In other words, each intra-gen share consists of multiple 2-out-of-2^{j} Shamir secret shares, although other schemes for secret sharing may be employed.

Accordingly, the generational structure 400 includes a first generation 402, a second generation 404, and a third generation 406. The first generation 402 includes two share parties, each party possessing an intra-gen share (at the end of the left arrow) and a multi-gen share (at the end of the right arrow and labeled with a ‘1’) for the first generation 402. The second generation 404 includes four share parties, each party possessing an intra-gen share (at the end of the left arrow) and two multi-gen shares (at the end of the right arrow and labeled with a ‘1’ and a ‘2’, respectively), one multi-gen share for the first generation 402 and another for the second generation 404. The third generation 406 includes eight share parties, each party possessing an intra-gen share (at the end of the left arrow) and three multi-gen shares (at the end of the right arrow and labeled with a ‘1’, a ‘2’, and a ‘3’, respectively), one multi-gen share for the first generation 402, another for the second generation 404, and another for the third generation 406.

The intuition behind the additional improvement provided by this implementation is that instead of every new share party having to receive one more function share than the previous share party, every new generation of share parties gets one more function share than the previous generation. Thus, the share size does not increase linearly with the number of share parties but instead increases logarithmically. For each new generation, the function share data size per share party increases by a small margin for the intra-gen share and by one share for inter-generational reconstruction.

In contrast to the evolving 2-threshold scheme for [symbol] _{d}( [symbol] ) described above, where the share size of Pₜ is t(d+1)log| [symbol] |, this generational implementation on top of the previous scheme to achieve a function secret sharing scheme where the function share array size of Pₜ is at most

$$\\ ( d + 1 ) ( ( ⌊ log t ⌋ + 2 ) log \vert 𝔽 \vert + ⌊ log t ⌋ + 1 ) .$$

For large t, the function share array sizes of this scheme are significantly smaller than the previous scheme, which has function share array sizes with linear dependence on t.

An ingredient of this implementation is reflected by the following lemma:

Lemma 1: Assume that there exists a perfectly secure evolving 2-threshold FSS scheme for [symbol] _{d}( [symbol] ), in which the share size of Pₜ is σ(t). Then, there exists a perfectly secure evolving 2-threshold FSS scheme for [symbol] _{d}( [symbol] ), in which the share size of Pₜ is

$$\\ \\ < ( d + 1 ) ( log \vert 𝔽 \vert + ⌊ log t ⌋ + 1 ) + σ ( ⌊ log t ⌋ + 1 ) .$$

Let Π be a perfectly secure evolving 2-threshold FSS scheme for [symbol] _{d}( [symbol] ), where the share size of Pₜ is σ(t). Each share party is assigned a generation, in particular, assigning Pₜ to generation g=└log t┘. This assignment scheme means that generation g has size 2^{g}.

### Dealing of Shares:

When the first party of a generation g arrives, the dealer prepares shares as follows:
1. Let [symbol] _{(g)} be the extension field of IF of minimal degree such that | [symbol] _{(g)}|≥2^{g}+1. Share a=(a₀, . . . , a_{d})∈ [symbol] ^{d+1} ⊆ [symbol] _{(g)}^{d+1} by sharing each coordinate of a using 2 out of 2^{g} Shamir secret sharing. Call the resulting shares u₁^{(g)}, . . . , u₂_{^{g}}^{(g)}. To be precise, we generate random polynomials q₀(X), . . . , q_{d}(X)∈ [symbol] _{(g)}[X], each of degree ≤1, such that qⱼ(0)=aⱼ for j=0, . . . , d, and let

$$\\ {u}_{i}^{{}_{} ( g )} = ( {q}_{0} ( i ) , … , {q}_{d} ( i ) )$$

for i=1, . . . , 2^{g}.
2. Generate a share of H, denoted v^{(g)}.

Now, the dealing party assigns share party P₂_{^{g}}₋₁₊ⱼ (the j-th party in generation g) the function share (uⱼ^{(g)}), v^{(g)}).

### Evaluation

Let Pᵢ and Pⱼ(with i<j) be two share parties. If Pᵢ and Pⱼ come from different generations g₁ and g₂, then they run the evaluation algorithm of Π on v^{(g}^{₁}⁾ and v^{(g}^{₂}⁾ to compute p(x).

Otherwise, if the share parties come from the same generation g, let Pᵢ be the i′-th party from the g-th generation and Pᵢ be the j′-th party. Then the evaluation algorithm works as follows:
1. Pᵢ computes Rs_{i,j}(x)=u_{i′}^{(g)}·(1, x, . . . , x^{d}),
2. Pⱼ computes Rs_{i,j}(x)=u_{j′}^{(g)}·(1, x, . . . , x^{d}),
3. computes the unique polynomial e(X)∈ [symbol] _{(g)} [X] of degree at most 1 such that Rs(i′)=Rs_{i,j}(x) and Rs(j′) Rs_{i,j}(x), and outputs Rs(0).

From the foregoing, a second corollary (Corollary 2) is as follows: There exists a perfectly secure evolving 2-threshold scheme for [symbol] _{d}( [symbol] ), where the share size of Pₜ is

$$\\ \\ < ( d + 1 ) ( ( ⌊ log t ⌋ + 2 ) log \vert 𝔽 \vert + ⌊ log t ⌋ + 1 ) .$$

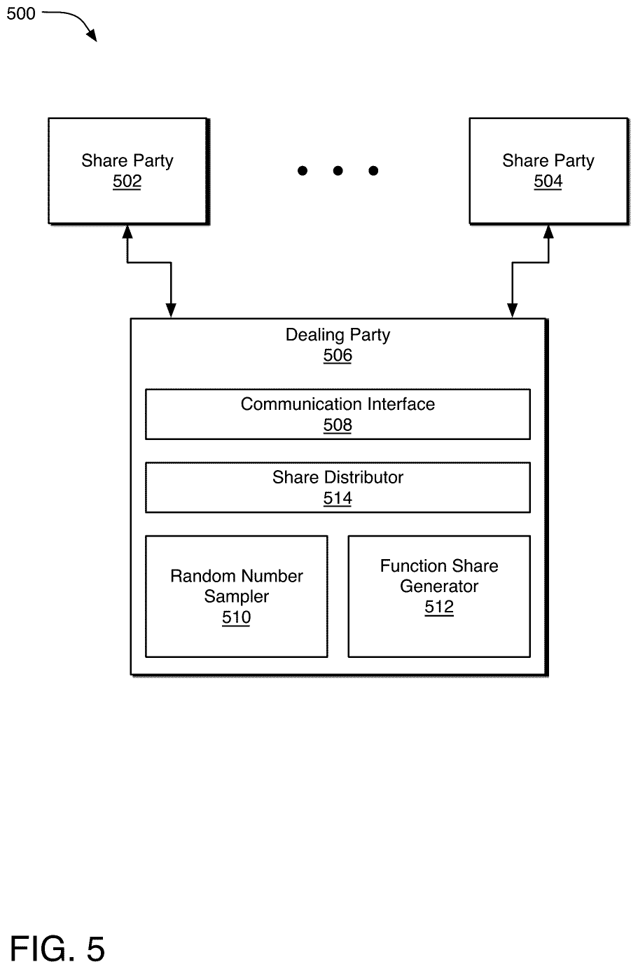

FIG. 5 illustrates an example system 500 for performing evolving function secret sharing on a given function by multiple share parties (see, e.g., a share party 502 and a share party 504). A dealing party 506 includes a communication interface 508 for communicating with other computing systems, storage systems, networking systems, etc. The dealing party 506 also includes a random vector sampler 510 executable by the one or more hardware processors. The communication interface 508 is configured to select a random vector corresponding each share party of a set of multiple share parties, the random vector of each share party corresponding to an arrival order at which each share party arrived to be added to a set of the multiple share parties. The dealing party 506 further stores the random vector corresponding to each share party for use in subsequent function share generation.

The dealing party 506 also includes a function share generator 512 executable by the one or more hardware processors. The function share generator 512 is configured to generate an array of function shares for each share party of the set of the multiple share parties. Each array includes a function share based on the random vector corresponding to the share party and one or more function shares cryptographically generated based on the random vector corresponding to each previously-arrived share party. The dealing party 506 also includes a share distributor 514 coupled to the communication interface 508. The share distributor 514 is executable by the one or more hardware processors and configured to distribute an array of the function shares to each share party. A first function share result is yielded from a computation of a first function share on given input data and at least a second function share result is yielded from a computation of a second function share on the given input data are combinable to yield a result of the given function executed on the given input data. The first function share is selected from an array of a previously-arrived share party, and the second function share is selected from an array of a later-arriving share party.

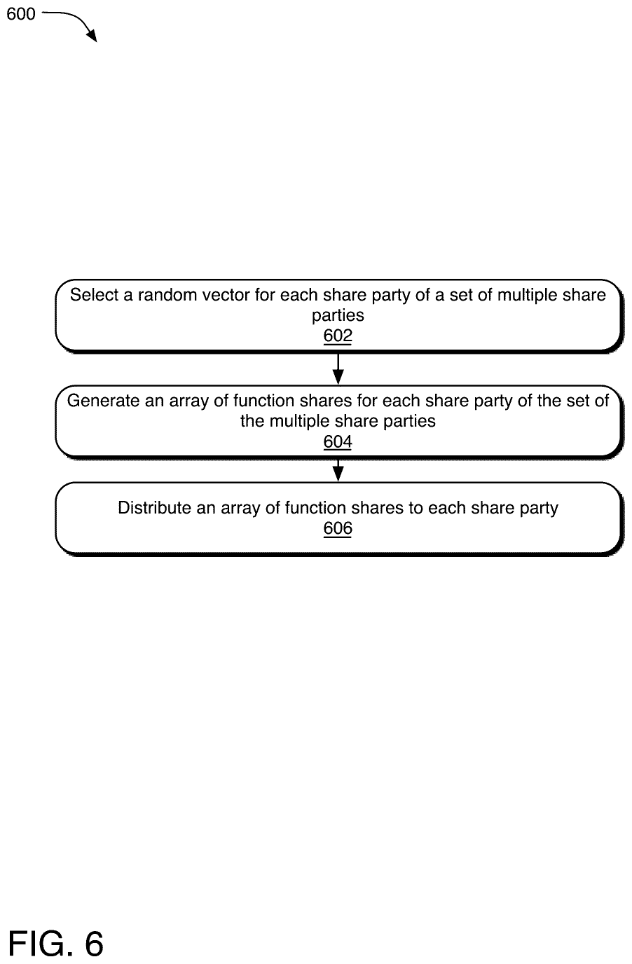

FIG. 6 illustrates example operations 600 for performing evolving function secret sharing on a given function by multiple share parties. A sampling operation 602 selects, by a dealing party, a random vector for each share party of a set of multiple share parties, the random vector of each share party corresponding to an arrival order at which each share party arrived to be added to a set of the multiple share parties. A generating operation 604 generates, by the dealing party, an array of function shares for each share party of the set of the multiple share parties, each array including a function share based on the random vector corresponding to the share party and one or more function shares cryptographically generated based on the random vector corresponding to each previously-arrived share party. A distributing operation 606 distributes an array to each share party, wherein a first function share result resulting from a computation of a first function share on given input data and at least a second function share result resulting from a computation of a second function share on the given input data are combinable to yield a result of the given function executed on the given input data, the first function share being selected from an array of a previously-arrived share party and the second function share being selected from an array of a later-arriving share party.

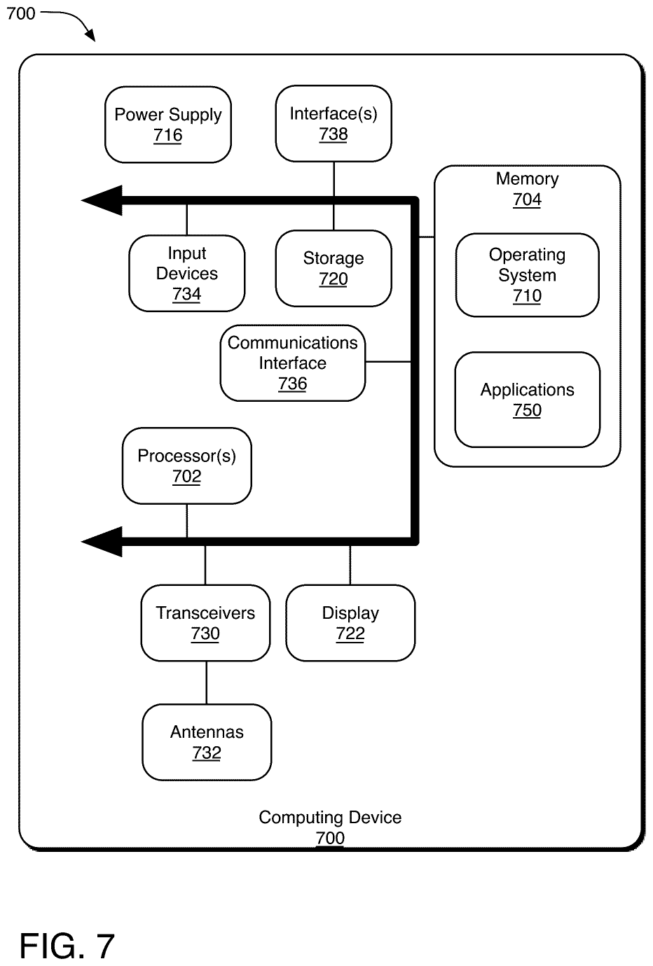

FIG. 7 illustrates an example computing device 700 for use in implementing the described technology. The computing device 700 may be a client computing device (such as a laptop computer, a desktop computer, or a tablet computer), a server/cloud computing device, an Internet-of-Things (IoT), any other type of computing device, or a combination of these options. The computing device 700 includes one or more hardware processor(s) 702 and a memory 704. The memory 704 generally includes both volatile memory (e.g., RAM) and nonvolatile memory (e.g., flash memory), although one or the other type of memory may be omitted. An operating system 710 resides in the memory 704 and is executed by the processor(s) 702. In some implementations, the computing device 700 includes and/or is communicatively coupled to storage 720.

In the example computing device 700, as shown in FIG. 7, one or more software modules, segments, and/or processors, such as applications 750, a communication interface, a random vector sampler, a function share generator, and a share distributor, and other program code and modules are loaded into the operating system 710 on the memory 704 and/or the storage 720 and executed by the processor(s) 702. The storage 720 may store random vectors, input data, functions, function shares, and share results, and other data and be local to the computing device 700 or may be remote and communicatively connected to the computing device 700. In particular, in one implementation, components of a system for performing evolving function secret sharing on a given function by multiple share parties may be implemented entirely in hardware or in a combination of hardware circuitry and software.

The computing device 700 includes a power supply 716, which may include or be connected to one or more batteries or other power sources, and which provides power to other components of the computing device 700. The power supply 716 may also be connected to an external power source that overrides or recharges the built-in batteries or other power sources.

The computing device 700 may include one or more communication transceivers 730, which may be connected to one or more antenna(s) 732 to provide network connectivity (e.g., mobile phone network, Wi-Fi®, Bluetooth®) to one or more other servers, client devices, IoT devices, and other computing and communications devices. The computing device 700 may further include a communications interface 736 (such as a network adapter or an I/O port, which are types of communication devices). The computing device 700 may use the adapter and any other types of communication devices for establishing connections over a wide-area network (WAN) or local-area network (LAN). It should be appreciated that the network connections shown are exemplary and that other communications devices and means for establishing a communications link between the computing device 700 and other devices may be used.

The computing device 700 may include one or more input devices 734 such that a user may enter commands and information (e.g., a keyboard, trackpad, or mouse). These and other input devices may be coupled to the server by one or more interfaces 738, such as a serial port interface, parallel port, or universal serial bus (USB). The computing device 700 may further include a display 722, such as a touchscreen display.

The computing device 700 may include a variety of tangible processor-readable storage media and intangible processor-readable communication signals. Tangible processor-readable storage can be embodied by any available media that can be accessed by the computing device 700 and can include both volatile and nonvolatile storage media and removable and non-removable storage media. Tangible processor-readable storage media excludes intangible and transitory communications signals (such as signals per se) and includes volatile and nonvolatile, removable and non-removable storage media implemented in any method, process, or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 700. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A computing-processor-implemented method of performing evolving function secret sharing on a given function by multiple share parties, the computing-processor-implemented method comprising: selecting, by a dealing party, a random vector for each share party of a set of multiple share parties, the random vector of each share party corresponding to an arrival order at which each share party arrived to be added to a set of the multiple share parties; generating, by the dealing party, an array of function shares for each share party of the set of the multiple share parties, each array including a function share based on the random vector corresponding to the share party and one or more function shares cryptographically generated based on the random vector corresponding to each previously-arrived share party, and distributing an array of the function shares to each share party, wherein a first function share result resulting from a computation of a first function share on given input data and at least a second function share result resulting from a computation of a second function share on the given input data are combinable to yield a result of the given function executed on the given input data, the first function share being selected from an array of a previously-arrived share party and the second function share being selected from an array of a later-arriving share party.

Clause 2. The computing-processor-implemented method of clause 1, wherein the first function share selected from the array of the previously-arrived share party selected from the array of the previously-arrived share party according to an array index corresponding to the previously-arrived share party.

Clause 3. The computing-processor-implemented method of clause 1, wherein the second function share is selected from the array of the later-arriving share party selected from an array of the later-arriving share party according to an array index corresponding to the previously-arrived share party.

Clause 4. The computing-processor-implemented method of clause 1, wherein function shares in each array are ordered in the array according to the arrival order of the multiple share parties.

Clause 5. The computing-processor-implemented method of clause 1, wherein each share party in the set of the multiple share parties is allocated to a generational set corresponding to the arrival order and receives an intra-generation function share for combining with another share party of a same generational set to yield the result of the given function executed on the given input data.

Clause 6. The computing-processor-implemented method of clause 1, wherein each share party in the set of the multiple share parties is allocated to a generational set corresponding to the arrival order and the function share based on the random vector corresponding to the share party corresponds to the generational set of the share party and the one or more function shares cryptographically generated based on the random vector corresponding to each previously-arrived share party correspond to the generational set of each previously-arrived share party.

Clause 7. The computing-processor-implemented method of clause 1, wherein each share party in the set of the multiple share parties is allocated to a generational set corresponding to the arrival order and each generational set and each successive generational set includes more share parties than a previous generational set.

Clause 8. A computing device for performing evolving function secret sharing on a given function by multiple share parties, the computing device comprising: one or more hardware processors; a random vector sampler executable by the one or more hardware processors and configured to select, by a dealing party, a random vector for each share party of a set of multiple share parties, the random vector of each share party corresponding to an arrival order at which each share party arrived to be added to a set of the multiple share parties; a function share generator executable by the one or more hardware processors and configured to generate, by the dealing party, an array of function shares for each share party of the set of the multiple share parties, each array including a function share based on the random vector corresponding to the share party and one or more function shares cryptographically generated based on the random vector corresponding to each previously-arrived share party, and a share distributor executable by the one or more hardware processors and configured to distribute an array of the function shares to each share party, wherein a first function share result resulting from a computation of a first function share on given input data and at least a second function share result resulting from a computation of a second function share on the given input data are combinable to yield a result of the given function executed on the given input data, the first function share being selected from an array of a previously-arrived share party and the second function share being selected from an array of a later-arriving share party.

Clause 9. The computing device of clause 8, wherein the first function share selected from the array of the previously-arrived share party selected from the array of the previously-arrived share party according to an array index corresponding to the previously-arrived share party.

Clause 10. The computing device of clause 8, wherein the second function share is selected from the array of the later-arriving share party selected from an array of the later-arriving share party according to an array index corresponding to the previously-arrived share party.

Clause 11. The computing device of clause 8, wherein function shares in each array are ordered in the array according to the arrival order of the multiple share parties.

Clause 12. The computing device of clause 8, wherein each share party in the set of the multiple share parties is allocated to a generational set corresponding to the arrival order and receives an intra-generation function share for combining with another share party of a same generational set to yield the result of the given function executed on the given input data.

Clause 13. The computing device of clause 8, wherein each share party in the set of the multiple share parties is allocated to a generational set corresponding to the arrival order and the function share based on the random vector corresponding to the share party corresponds to the generational set of the share party and the one or more function shares cryptographically generated based on the random vector corresponding to each previously-arrived share party correspond to the generational set of each previously-arrived share party.

Clause 14. The computing device of clause 8, wherein each share party in the set of the multiple share parties is allocated to a generational set corresponding to the arrival order and each generational set and each successive generational set includes more share parties than a previous generational set.

Clause 15. One or more tangible processor-readable storage media embodied with instructions for executing on one or more processors and circuits of a computing device a process for performing evolving function secret sharing on a given function by multiple share parties, the process comprising: selecting, by a dealing party, a random vector for each share party of a set of multiple share parties, the random vector of each share party corresponding to an arrival order at which each share party arrived to be added to a set of the multiple share parties; generating, by the dealing party, an array of function shares for each share party of the set of the multiple share parties, each array including a function share based on the random vector corresponding to the share party and one or more function shares cryptographically generated based on the random vector corresponding to each previously-arrived share party, and distributing an array of the function shares to each share party, wherein a first function share result resulting from a computation of a first function share on given input data and at least a second function share result resulting from a computation of a second function share on the given input data are combinable to yield a result of the given function executed on the given input data, the first function share being selected from an array of a previously-arrived share party and the second function share being selected from an array of a later-arriving share party.

Clause 16. The one or more tangible processor-readable storage media of clause 15, wherein the first function share selected from the array of the previously-arrived share party selected from the array of the previously-arrived share party according to an array index corresponding to the previously-arrived share party.

Clause 17. The one or more tangible processor-readable storage media of clause 15, wherein the second function share is selected from the array of the later-arriving share party selected from an array of the later-arriving share party according to an array index corresponding to the previously-arrived share party.

Clause 18. The one or more tangible processor-readable storage media of clause 15, wherein function shares in each array are ordered in the array according to the arrival order of the multiple share parties.

Clause 19. The one or more tangible processor-readable storage media of clause 15, wherein each share party in the set of the multiple share parties is allocated to a generational set corresponding to the arrival order and receives an intra-generation function share for combining with another share party of a same generational set to yield the result of the given function executed on the given input data.

Clause 20. The one or more tangible processor-readable storage media of clause 15, wherein each share party in the set of the multiple share parties is allocated to a generational set corresponding to the arrival order and the function share based on the random vector corresponding to the share party corresponds to the generational set of the share party and the one or more function shares cryptographically generated based on the random vector corresponding to each previously-arrived share party correspond to the generational set of each previously-arrived share party.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A computing-processor-implemented method of performing evolving function secret sharing on a given function by multiple share parties, the computing-processor-implemented method comprising:
selecting, by a dealing party, a random vector for each share party of a set of multiple share parties, the random vector of each share party corresponding to an arrival order at which each share party arrived to be added to a set of the multiple share parties;
generating, by the dealing party, an array of function shares for each share party of the set of the multiple share parties, each array including a function share based on the random vector corresponding to the share party and one or more function shares cryptographically generated based on the random vector corresponding to each previously-arrived share party, and
distributing an array of the function shares to each share party, wherein a first function share result resulting from a computation of a first function share on given input data and at least a second function share result resulting from a computation of a second function share on the given input data are combinable to yield a result of the given function executed on the given input data, the first function share being selected from an array of a previously-arrived share party and the second function share being selected from an array of a later-arriving share party.

2. The computing-processor-implemented method of claim 1, wherein the first function share selected from the array of the previously-arrived share party selected from the array of the previously-arrived share party according to an array index corresponding to the previously-arrived share party.

3. The computing-processor-implemented method of claim 1, wherein the second function share is selected from the array of the later-arriving share party selected from an array of the later-arriving share party according to an array index corresponding to the previously-arrived share party.

4. The computing-processor-implemented method of claim 1, wherein function shares in each array are ordered in the array according to the arrival order of the multiple share parties.

5. The computing-processor-implemented method of claim 1, wherein each share party in the set of the multiple share parties is allocated to a generational set corresponding to the arrival order and receives an intra-generation function share for combining with another share party of a same generational set to yield the result of the given function executed on the given input data.

6. The computing-processor-implemented method of claim 1, wherein each share party in the set of the multiple share parties is allocated to a generational set corresponding to the arrival order and the function share based on the random vector corresponding to the share party corresponds to the generational set of the share party and the one or more function shares cryptographically generated based on the random vector corresponding to each previously-arrived share party correspond to the generational set of each previously-arrived share party.

7. The computing-processor-implemented method of claim 1, wherein each share party in the set of the multiple share parties is allocated to a generational set corresponding to the arrival order and each generational set and each successive generational set includes more share parties than a previous generational set.

8. A computing device for performing evolving function secret sharing on a given function by multiple share parties, the computing device comprising:
one or more hardware processors;
a random vector sampler executable by the one or more hardware processors and configured to select, by a dealing party, a random vector for each share party of a set of multiple share parties, the random vector of each share party corresponding to an arrival order at which each share party arrived to be added to a set of the multiple share parties;
a function share generator executable by the one or more hardware processors and configured to generate, by the dealing party, an array of function shares for each share party of the set of the multiple share parties, each array including a function share based on the random vector corresponding to the share party and one or more function shares cryptographically generated based on the random vector corresponding to each previously-arrived share party, and
a share distributor executable by the one or more hardware processors and configured to distribute an array of the function shares to each share party, wherein a first function share result resulting from a computation of a first function share on given input data and at least a second function share result resulting from a computation of a second function share on the given input data are combinable to yield a result of the given function executed on the given input data, the first function share being selected from an array of a previously-arrived share party and the second function share being selected from an array of a later-arriving share party.

9. The computing device of claim 8, wherein the first function share selected from the array of the previously-arrived share party selected from the array of the previously-arrived share party according to an array index corresponding to the previously-arrived share party.

10. The computing device of claim 8, wherein the second function share is selected from the array of the later-arriving share party selected from an array of the later-arriving share party according to an array index corresponding to the previously-arrived share party.

11. The computing device of claim 8, wherein function shares in each array are ordered in the array according to the arrival order of the multiple share parties.

12. The computing device of claim 8, wherein each share party in the set of the multiple share parties is allocated to a generational set corresponding to the arrival order and receives an intra-generation function share for combining with another share party of a same generational set to yield the result of the given function executed on the given input data.

13. The computing device of claim 8, wherein each share party in the set of the multiple share parties is allocated to a generational set corresponding to the arrival order and the function share based on the random vector corresponding to the share party corresponds to the generational set of the share party and the one or more function shares cryptographically generated based on the random vector corresponding to each previously-arrived share party correspond to the generational set of each previously-arrived share party.

14. The computing device of claim 8, wherein each share party in the set of the multiple share parties is allocated to a generational set corresponding to the arrival order and each generational set and each successive generational set includes more share parties than a previous generational set.

15. One or more tangible processor-readable storage media embodied with instructions for executing on one or more processors and circuits of a computing device a process for performing evolving function secret sharing on a given function by multiple share parties, the process comprising:
selecting, by a dealing party, a random vector for each share party of a set of multiple share parties, the random vector of each share party corresponding to an arrival order at which each share party arrived to be added to a set of the multiple share parties;
generating, by the dealing party, an array of function shares for each share party of the set of the multiple share parties, each array including a function share based on the random vector corresponding to the share party and one or more function shares cryptographically generated based on the random vector corresponding to each previously-arrived share party, and
distributing an array of the function shares to each share party, wherein a first function share result resulting from a computation of a first function share on given input data and at least a second function share result resulting from a computation of a second function share on the given input data are combinable to yield a result of the given function executed on the given input data, the first function share being selected from an array of a previously-arrived share party and the second function share being selected from an array of a later-arriving share party.

16. The one or more tangible processor-readable storage media of claim 15, wherein the first function share selected from the array of the previously-arrived share party selected from the array of the previously-arrived share party according to an array index corresponding to the previously-arrived share party.

17. The one or more tangible processor-readable storage media of claim 15, wherein the second function share is selected from the array of the later-arriving share party selected from an array of the later-arriving share party according to an array index corresponding to the previously-arrived share party.

18. The one or more tangible processor-readable storage media of claim 15, wherein function shares in each array are ordered in the array according to the arrival order of the multiple share parties.

19. The one or more tangible processor-readable storage media of claim 15, wherein each share party in the set of the multiple share parties is allocated to a generational set corresponding to the arrival order and receives an intra-generation function share for combining with another share party of a same generational set to yield the result of the given function executed on the given input data.

20. The one or more tangible processor-readable storage media of claim 15, wherein each share party in the set of the multiple share parties is allocated to a generational set corresponding to the arrival order and the function share based on the random vector corresponding to the share party corresponds to the generational set of the share party and the one or more function shares cryptographically generated based on the random vector corresponding to each previously-arrived share party correspond to the generational set of each previously-arrived share party.
